(19) United States
(12) Patent Application Publication
(10) Pub. No.: US 2010/0237120 A1
(43) Pub. Date: Sep. 23, 2010

(54) COUPLING DEVICE RELEASABLY ATTACHING ACCESSORIES TO A BICYCLE

(75) Inventor: Alois Mühlberger, Koln (DE)

Correspondence Address: PAULEY PETERSEN & ERICKSON, 2800 WEST HIGGINS ROAD, SUITE 365, HOFFMAN ESTATES, IL, 60169, US

(73) Assignee: Muhlberger GmbH, Koln (DE)

(21) Appl. No.: 12/733,751

(22) PCT Filed: Jul. 25, 2008
(86) PCT No.: PCT/EP2008/006112

§ 371 Date: Mar. 18, 2010

(30) Foreign Application Priority Data
Sep. 21, 2007 (DE) 202007013296.4
Dec. 5, 2007 (DE) 202007016987.6
Feb. 16, 2008 (DE) 202008002164.2
Feb. 20, 2008 (DE) 2502008002325.4
Mar. 5, 2008 (DE) 202008003149.4
May 7, 2008 (DE) 202008006275.6

(51) Int. Cl. B60R 11/00

(52) U.S. Cl. 224/562

(57) ABSTRACT

A coupling device for releasably attaching accessories to a bicycle, with a coupling part which is fastened or can be fastened to the accessory and has a retaining section which can be coupled on by being pushed in, and with a coupling unit designed for receiving the retaining section, is permanently integrated on the bicycle or is fastened to the bicycle by a connection element and has a receiving section for pushing in the retaining section. Various optional and uniform coupling options are obtained by coupling units, each identical, being permanently integrated at a plurality of points on the bicycle, or by provision of differently designed connectors with which separate coupling units can be equipped and can be attached to different points on the bicycle, and by the coupling parts configured so that they are attached or can be attached to various types of accessories.

### BACKGROUND OF THE INVENTION

1. Field of the Invention

This invention relates to a coupling device for releasably attaching accessories to a bicycle, having a coupling part that is fastened to the accessory or that can be fastened to it and having a retaining section that can be mounted by being inserted into place and having a coupling unit which is designed to receive the retaining section, is permanently integrated into the bicycle or fastened to it by a connecting element, and has a receiving section for insertion of the retaining section.

2. Discussion of Related Art

On a bicycle, detachable accessories such as containers and other luggage rack devices, bicycle computers, detachable lamps, and the like are coupled in place by coupling parts, which are attached to the accessory and are frequently embodied as hook elements that are hooked onto a component of the bicycle. As a result, there is a wide variety of coupling elements and types of attachment.

A coupling device is known from PCT International Publication WO 2008/006577 A1. In this known coupling device, a coupling unit with a receiving section is integrated into a handlebar stem, particularly its protruding section, and a coupling part that is adapted to this receiving section and is attached to an accessory such as a computer or container that can be inserted into the receiving section.

French Patent Reference FR 2 494 659 A 1 discloses another coupling device for attaching an accessory to the handlebar stem of a bicycle. The fastening section of this coupling device is for mounting electrically operated accessories.

Panniers are frequently attached to luggage racks by hooks and clasps or belts with hook-and-loop fasteners. Similar fastening means for such accessories are also used for attachment in the handlebar region of the bicycle.

### SUMMARY OF THE INVENTION

One object of this invention is to provide a coupling device of the type mentioned above, but that offers numerous coupling options and is easy to use.

This object can be attained with a coupling device having characteristics taught in the claims and this specification. Identical coupling units are permanently integrated into a plurality of locations on the bicycle or differently embodied connecting devices are provided, which can be equipped with separate coupling units and attached to the bicycle at different locations, and the coupling parts are or can be attached to various types of accessories.

These measures offer a variety of stable, uniquely defined mounting options for various types of accessories and/or in various locations on the bicycle. When the coupling part and coupling unit are embodied in the same way, it is thus also possible, for example, to mount a particular accessory in the same way to various locations on a bicycle.

Advantageous embodiments are disclosed in the claims and in this specification.

In one embodiment of the coupling device, the coupling units are integrated into or embodied with the capacity to be connected to a handlebar tube, a fork, a down tube of the bicycle frame, a top tube of the bicycle frame, a seat post, a seat tube, a luggage rack component or a holder mounted on the luggage rack, or a plurality of these basic components of a bicycle offers various advantageous mounting possibilities in various positions on the bicycle. In one embodiment, an additional coupling unit is integrated into or embodied with the capacity to be connected to a handlebar stem of the bicycle.

A secure, easy-to-operate coupling is achieved if the coupling part has a locking element, the coupling unit has a locking receptacle complementary to this locking element, and the locking element and locking receptacle automatically engage with each other when the coupling part and the coupling unit are completely slid into each other.

A reliable, secure function is achieved if the locking element and locking receptacle snap into each other by a spring force when the coupling part and the coupling unit are slid into each other and in order to release the locking action, the locking element and/or the locking receptacle each has a handle.

In some embodiments for equipping an accessory with a coupling part, at least one coupling part is attached to the accessory or can be attached to it by at least one screw connection or rivet connection, a welded connection or soldered connection, a bracket, an adhesive connection, a hook-and-loop connection, a detent connection, a clasp, or by a support plate.

The bicycle can have coupling units if at least one coupling unit is attached to the bicycle by at least one screw connection or rivet connection, a welded connection or soldered connection, a bracket, an adhesive connection, a hook-and-loop connection, a detent connection, a clasp, or by a support element.

The coupling, particularly also of a larger accessory, is further facilitated if the coupling part and the coupling unit are secured in their slid-together state by a permanent magnet holder.

In some embodiments, the permanent magnet holder has a permanent magnet positioned remote from the coupling region of the coupling part and coupling unit on the accessory or bicycle and has a magnetic or magnetizable counterpart element force-coupled to the bicycle or accessory.

In another embodiment of this invention, the accessory is a container, a coupling part is mounted on both a wall side and a bottom side of the container, and the container is coupled to a seat post or seat tube by the wall-mounted coupling part and is coupled to a mudguard, which has a coupling unit by the bottom coupling part.

The measures mentioned above achieve a variety of combination possibilities for different accessories and their positioning on a bicycle using coupling elements embodied identically and having a secure function while being easy to use.

### BRIEF DESCRIPTION OF THE DRAWINGS

This invention is explained in view of embodiments shown in the drawings, wherein:

FIG. 1A is a perspective view of a coupling part for accessories;

FIG. 1B is a side view of the coupling part according to FIG. 1A;

FIG. 1C is a schematic front view of another embodiment of the coupling part;

FIG. 1D is a side view of the coupling part according to FIG. 1C;

FIG. 1E is a top view of an open embodiment of a coupling unit for attachment to a bicycle component;

FIG. 1F is a top view of another embodiment of a coupling unit with a closed receiving section;

FIG. 2A shows a side view of a bicycle frame with an attached luggage rack, a handlebar stem, a fork, and a seat post, with coupling units in various positions;

FIG. 2B shows a coupling unit integrated into a bracket part of the bicycle;

FIG. 3A shows a coupling unit on a bicycle frame, particularly in a permanently integrated embodiment;

FIG. 3B shows a coupling unit built into a bicycle frame, in particular permanently integrated into it, in a closed embodiment;

FIG. 3C shows another coupling unit built into a bicycle frame, in particular permanently integrated into it, in an open embodiment;

FIG. 4 shows coupling units attached to a luggage rack of a bicycle;

FIG. 5 shows a coupling part attached to a pannier;

FIG. 6 shows a securing system that can be attached to a luggage rack of a bicycle and that has a plurality of coupling units and a supplementary securing part;

FIG. 7 shows another embodiment securing system that can be attached to a luggage rack of a bicycle and that has a plurality of coupling units integrated into it as well as a supplementary securing part;

FIG. 8 shows a perspective view and a side view of a support plate, which has a coupling part and an additional securing part and a container that accommodates the support plate;

FIG. 9 shows another embodiment of a coupling unit with fastening elements for attachment to bicycle components;

FIG. 10 shows a top view and a perspective view of a coupling unit formed as a clamping bracket;

FIG. 11 is a perspective view of a coupling part for attachment to an accessory by a mounting bracket;

FIG. 12 is a lateral, partially perspective view of a pannier with a coupling part attached to a side wall and a mudguard coupled to a bottom wall;

FIG. 13 is a perspective view of a coupling part attached to a bottle holder; and

FIG. 14 is a perspective view of a coupling part attached to a dual bottle holder.

### DETAILED DESCRIPTION OF THE INVENTION

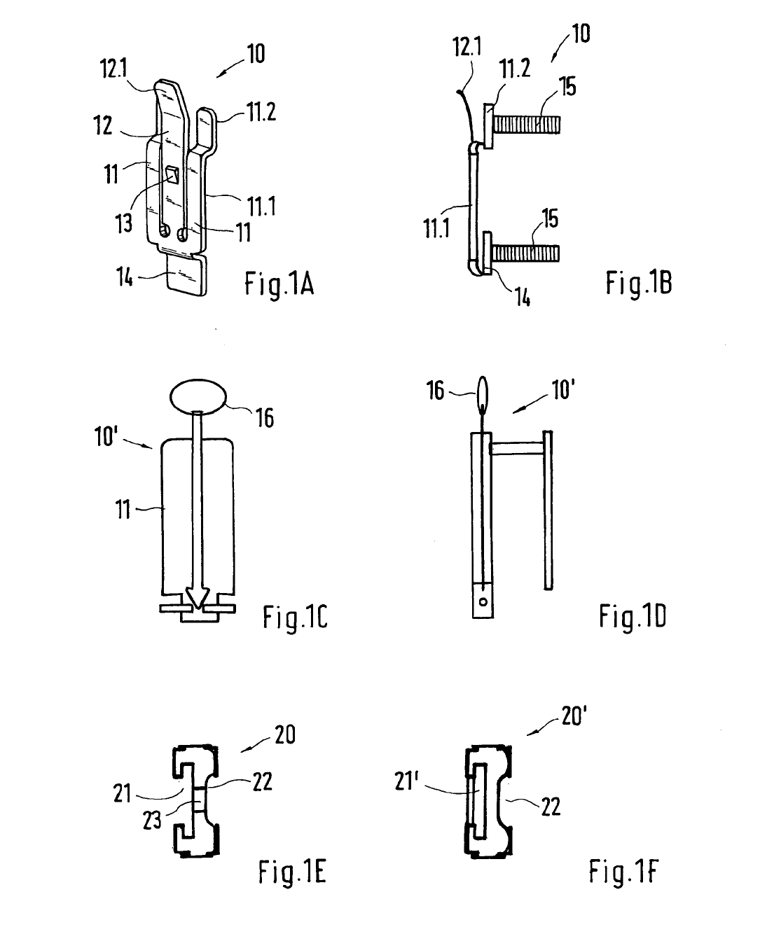

FIGS. 1A and 1B show a perspective view and a side view, respectively, of a coupling part 10 for attachment to a bicycle accessory, such as containers including a pannier or a basket, bottles with or without racks, a pump, a light unit, a bicycle computer, or the like, which can be slid into and locked in a matching coupling unit 20 according to FIG. 1E. Another embodiment of a coupling part 10′ is shown from the front in FIG. 1C and from the side in FIG. 1D. This alternative embodiment can be coupled to another correspondingly adapted coupling unit 20′ according to FIG. 1F by sliding into it. The coupling units 20 according to FIGS. 1E and 20′ according to FIG. 1F differ from each other because the one according to FIG. 1E is embodied as open and the other according to FIG. 1F is embodied as closed.

As shown in FIGS. 1A and 1B, the coupling part 10, which is embodied for example as a stamped, bent part manufactured from a flat sheet metal plate or is produced in the form of a molded plastic part, has lateral securing sections 11 extending parallel to each other, which have guide sections 11.1 extending along their narrow longitudinal edges extending in the insertion direction for insertion into lateral grooves of a cross-sectionally T-shaped receiving section 21 of the coupling unit 20, according to FIG. 1E in a sliding, precisely fitting fashion. A central locking section 12 situated between the lateral securing sections 11 is formed as a tongue and is divided from the securing sections 11 by lateral incisions and is only contiguously connected to the material of the securing sections 11 at its one narrow end. At the end of each incision, a respective bore is provided to improve a resilient attachment of the locking section 12 with regard to its functional properties. At its other free end, the locking section 12 is bent slightly out from its plane to form a handle 12.1 for a simple pivoting actuation to release the locking section 12. On one flat side, the locking section 12 has a locking element 12 that protrudes up from or is recessed into its plane, which when the coupling part 10 is in its inserted position in the coupling unit 20, snaps into a locking position in relation to a correspondingly positioned recessed or protruding locking receptacle 23 that is at least to a large extent matched to it in size and shape and can be embodied to engage in detent fashion. As a result, the coupling part 10 is held in the coupling unit 20 in a stable, secure fashion when the accessory is coupled to the bicycle.

For a uniquely defined positioning of the coupling part 10 in its fully inserted position in the coupling unit 20, the free end regions of the coupling part 10 are bent twice by approximately 90° into a Z-shape, thus producing a shoulder with which the securing sections 11 come into contact with the top surface or a correspondingly embodied counterpart section of the coupling unit 20. At the insertion end, the coupling part 10 has a tongue-like insertion section 14 whose width is adapted to the opening side of the receiving section 21 of the coupling unit 20 and is likewise embodied in a Z-shape by a double bend, on a side corresponding to that of the delimiting sections 11.2 of the two securing sections 11. In the inserted state, the insertion section 14 is thus situated in the opening region of the receiving section 21. The shoulder formed by the double bend can likewise be used for support in the lower region of the receiving section 21 in the insertion direction with a corresponding embodiment of this lower region and, together with the guide edges 11.1 of the securing sections 11, contributes to a uniquely defined guidance and a secure seating.

In order to attach the coupling part 10 to the accessory, it has fastening elements 15, for example, in the form of screws or rivets or alternatively or additionally, a hook-and-loop fastener or a fastening belt or eyelets for a fastening belt.

In the embodiment according to FIGS. 1C and 1D, the coupling part 10′ is embodied to be inserted with a disk part with lateral securing sections 11 into a receiving section 21′ of the coupling unit 20′ according to FIG. 1F that is closed on its side oriented toward the accessory. The insertion part extends completely freely in its region oriented in the insertion direction and only in its rear region in the insertion direction, is attached to the accessory or a connecting unit provided for attachment to the accessory. With a grip piece 16, the coupling part 10′ can be pulled out of the correspondingly adapted receiving section 21′. It is also possible to provide a locking element in order to automatically lock the coupling part 10′ in its inserted position in the receiving section 21′ and in order to release it by manual actuation.

As also shown in FIGS. 1E and 1F, on its side oriented away from the receiving section 21, 21′, the coupling unit 20, 20′ has a connecting section 22 by which it can be brought into stable contact with a bicycle component and attached thereto, for example by welding, soldering, adhesive, screws or rivets, or for example also by a clamping bracket 50, as shown in FIG. 10, or other anchoring clamps. The coupling unit 20, 20′ can be permanently integrated into the bicycle component, for example a part of the frame.

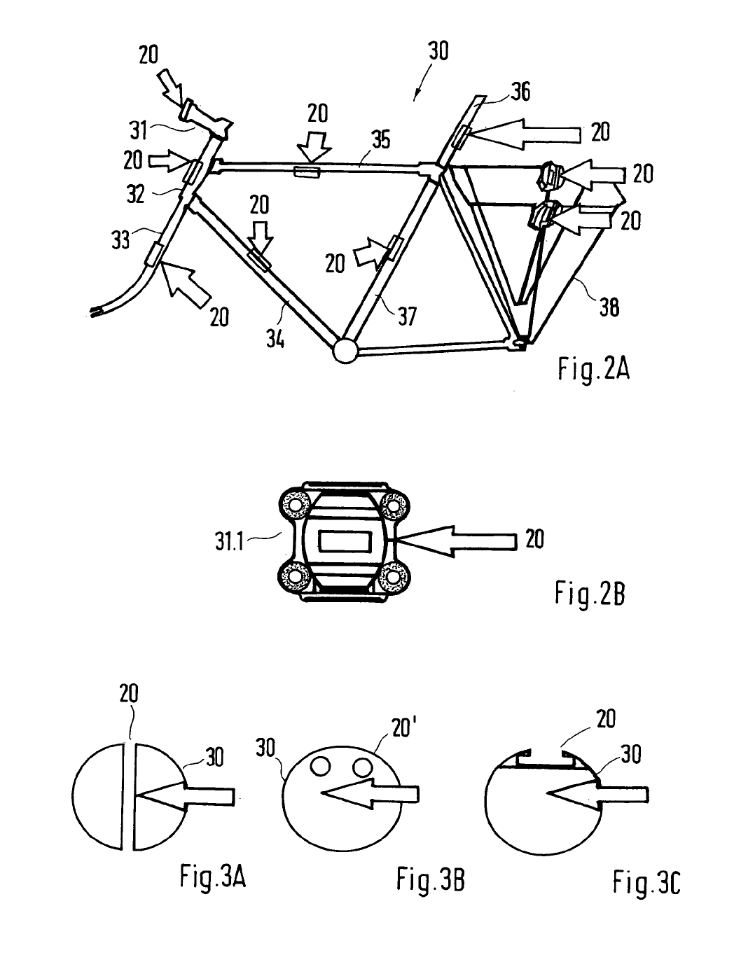

FIG. 2A shows various useful arrangements of coupling units 20 on components of a bicycle, in particular a frame 30, which has a handlebar stem 31, a fork 33, a seat post 36, and a luggage rack with support rods 38. In this case, coupling units 20 are attached to the handlebar stem 31, the head tube 32, the fork 33, the down tube 34 of the bicycle frame, the top tube 35 of the bicycle frame, the seat post 36, the seat tube 37, and the support rods of the luggage rack 38. The coupling units attached to the actual bicycle frame, comprising the head tube 32, the down tube 34, the top tube 35, and the seat tube 37, can be permanently integrated into these frame components from the beginning, thus yielding certain positions with a stable attachment of the coupling units 20 or alternatively 20′. In addition, coupling units 20 or 20′ can also be permanently integrated into the fork 33, the handlebar stem 31, for example the protruding part of it, and the seat post 36 and can already be affixed to the luggage rack 38 at the manufacturer. It is possible for one or more coupling units 20 or 20′ to be integrated into or permanently attached to one or more of the bicycle components from the beginning and to subsequently equip them with additional ones as needed.

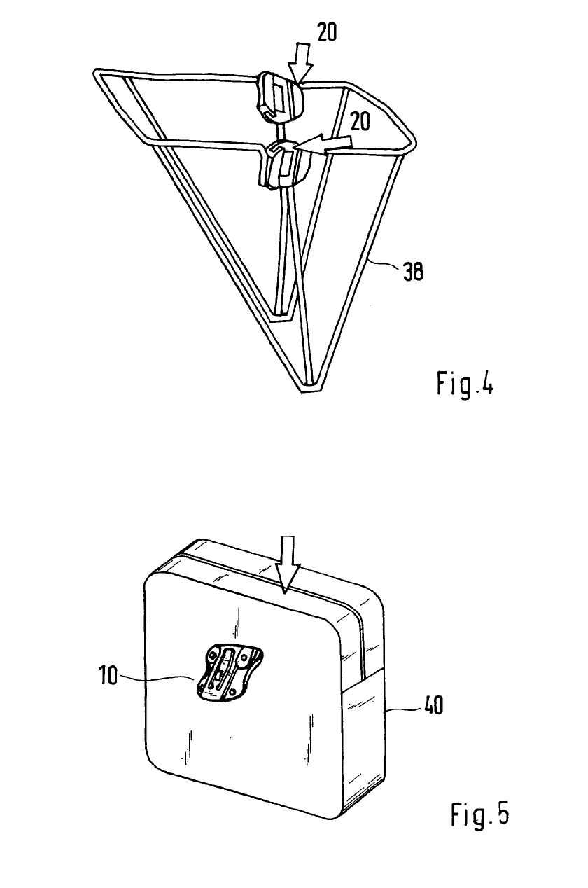

In an embodiment shown in FIG. 2B, a coupling unit 20 is permanently integrated into a clamping part 31.1 of the handlebar stem 31, which is used to mount a pair of handlebars. In the embodiments according to FIGS. 3A and 3C, open embodiments of a coupling unit 20 are permanently integrated into the bicycle frame 30 from the beginning or are attached to it, while FIG. 3B shows one embodiment in which a closed coupling unit 20′ is integrated into a bicycle frame.

FIG. 4 shows a luggage rack 38 in which, in accordance with FIG. 2A, coupling units 20 are mounted in the upper transition region between lateral and upper support rods, while FIG. 5 shows a container 40 in the form of a pannier, on the one side wall of which a coupling part 10 is attached to a corresponding support plate, such as by rivets, which plate is attached to the pannier or is attached to it from the beginning.

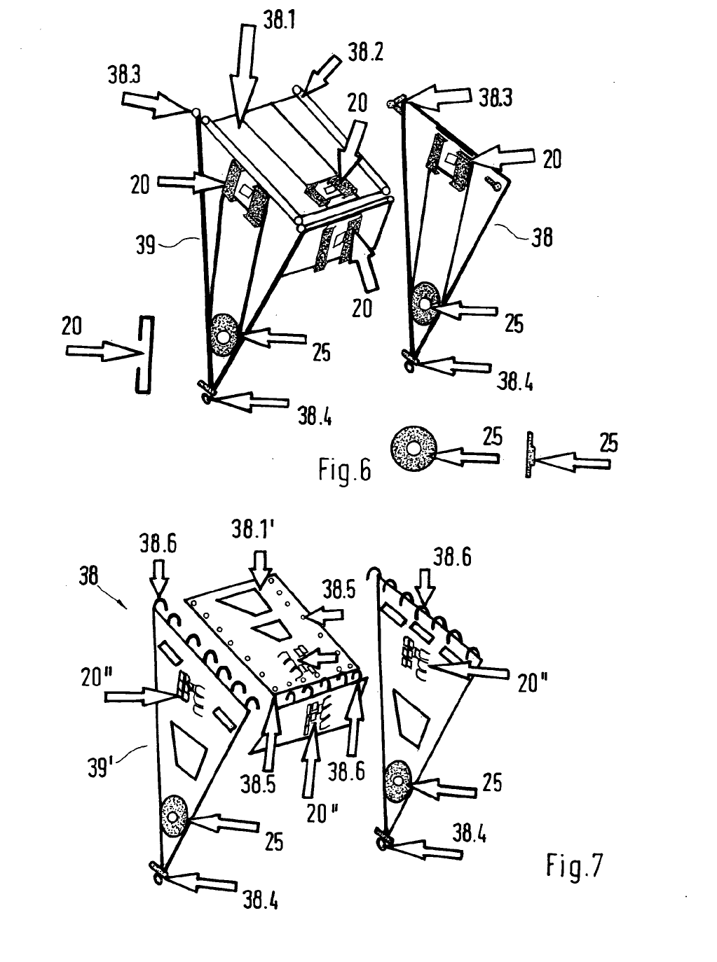

In the embodiment according to FIG. 6, coupling units 20 are mounted to a support system that can be attached to a luggage rack and includes lateral parts 39, a top part, and a rear part. The support system can be mounted to a luggage rack 38 with an upper part 38.1 and can be clamped in the upper luggage rack region by longitudinal stays 38.2 and fastening screws 38.3 and can also be additionally clamped to the lateral parts 39 in the lower lateral region of the pannier by an additional fastening part 38.4.

In order to improve the securing of a large-area accessory part such as a side bag, additional securing parts 25 are situated for example in the two lower lateral regions of the lateral parts 39 of the support system and when the relevant coupling part 10, 10′ is in its fully inserted position in the associated coupling unit 20, 20′, the additional securing parts 25 come into detachable connection with adapted securing parts 17, for example by magnetic force and advantageously, additionally by form-locking engagement. The securing parts 25, 17 can also be formed as clips, snaps, or detent connections.

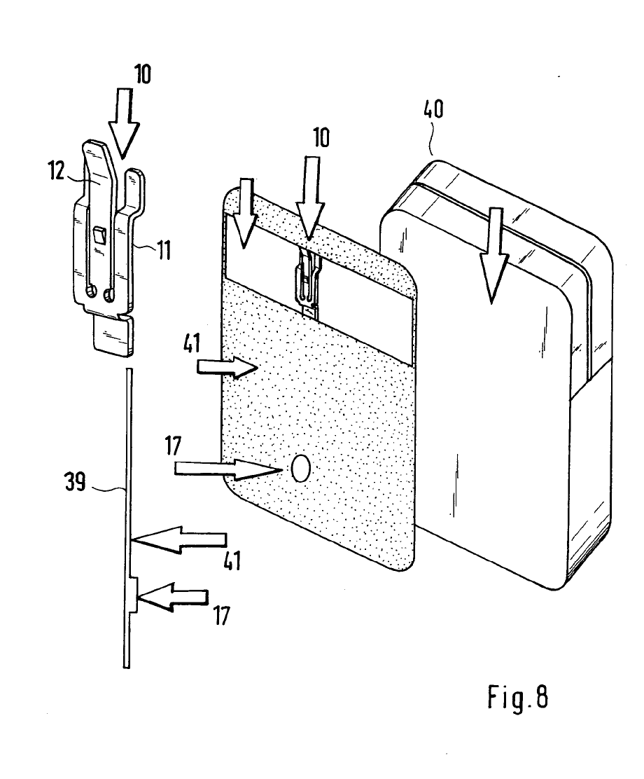

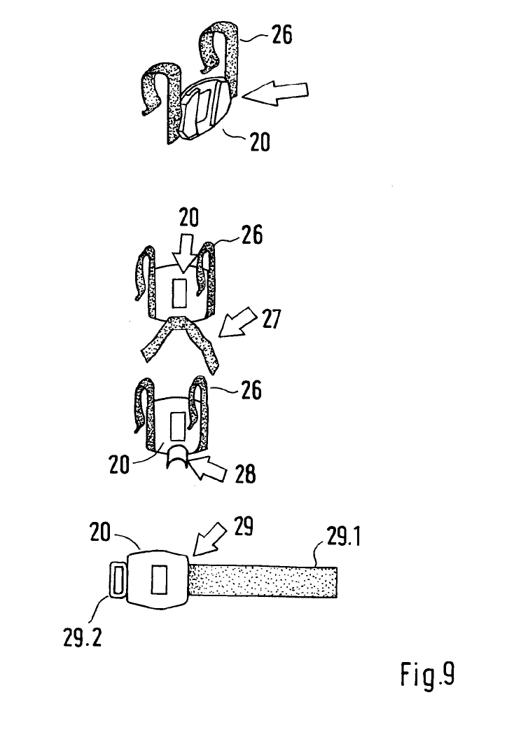

FIG. 7 shows another support system 39′ in which a top part 38.1′, the side parts 39′, and a rear part are embodied as plate-shaped. The plate-shaped parts have coupling units 20″ integrated into them, which are embodied in the form of stamped and bent components and are embodied for the insertion of a coupling part 10 with its securing sections 11. Here, a locking receptacle 23 is embodied in the plate parts, in the region of or near the receiving section 21. A securing part 25 is again situated in the lower section of the side parts 39′, as shown in FIG. 6, which offers a supplemental securing, advantageously by magnetic force, for a larger accessory such as a side bag with a securing part 17 positioned on it in corresponding fashion, such as shown in FIG. 8. For example, by hooks 38.6 attached to their upper edge, the side parts 39′ are hooked into hook openings 38.5 accommodated on the associated longitudinal edge of the top part 38.1 and are secured by fastening parts 38.4 in the lower lateral region of the luggage rack or a corresponding frame region of the bicycle. Correspondingly, the rear plate is also attached to the top part 38.1′ of the support system by hooks 38.6 and hook openings 38.5.

FIG. 8 shows an accessory or container 40 in the form of a pannier that can be attached to the side of a luggage rack 38 or support system with lateral parts 39, 39′. On its side wall oriented toward the lateral parts 39, 39′ or the lateral region of the luggage rack 38, the container 40 has a support plate 41 whose upper region has a coupling part 10 attached to it, while a securing part 17 is attached to or embodied in the lower region of the support plate and comes into a securing connection with the securing part 25 when the coupling part 10 is in its inserted position in an associated coupling unit 20. Advantageously, at least one of the securing parts 25, 17 has a permanent magnet while the opposing securing part 17 either has a permanent magnet or a ferromagnetic material to produce a connection by magnetic force and optionally also by form-locking engagement.

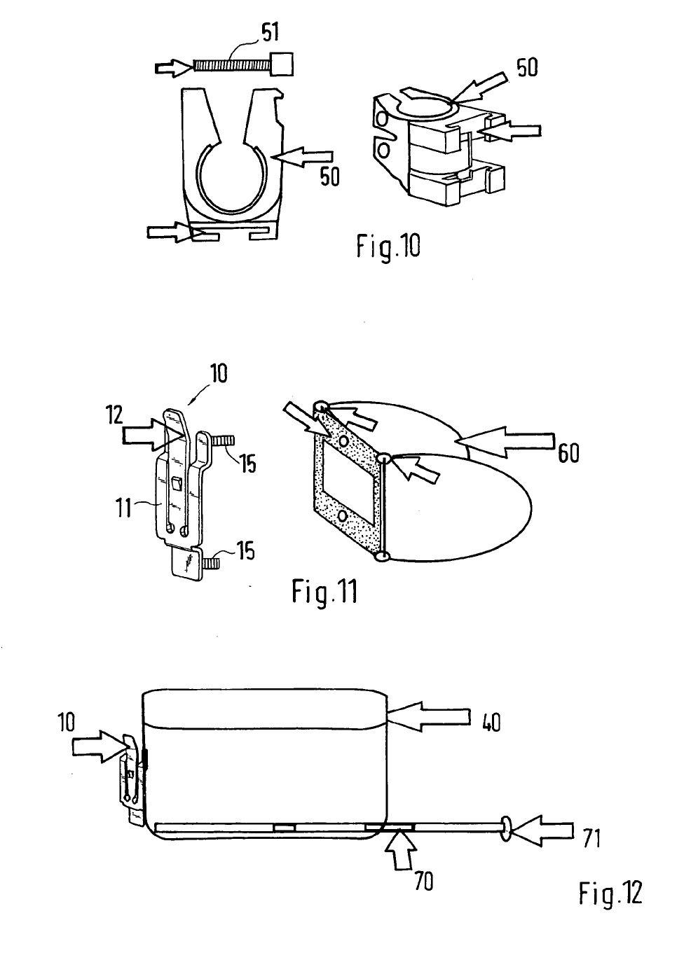

FIG. 9 shows various embodiments of fastening devices for a coupling unit 20 for subsequent attachment to a bicycle, such as an arrangement of fastening hooks 26 attached to the coupling unit 20, which hooks permit, for example, a clamped attachment to an upper luggage rack rod, with the hooks largely surrounding the rod in a resilient fashion and holding it secured by an elastic spring force. The free ends of the hooks are bent outward to produce an advantageous bevel to allow the fastening hooks 26 to be easily set into position in a uniquely defined way and pushed into place. In addition to the fastening hooks 26, additional fastening parts can be attached to the coupling unit 20, for example a fastening belt with a clasp or hook-and-loop fastener 27 or a connecting clamp 28 to be secured in a snapping fashion or with a screw. Alternatively or additionally, the coupling unit 20 can have securing eyelets attached to it for a fastening belt 29.1 with an eyelet 29.2 or can have hook-and-loop elements attached to it in order to attach the coupling unit 20, even only temporarily, to a suitable component of the bicycle.

As mentioned above, FIG. 10 shows a clamping bracket 50 with a coupling unit 20 attached to it or integrated into it for attaching the clamping bracket to a tube of the bicycle frame 30 or to the seat post 36, advantageously by a clamping screw 51. The clamping bracket 50 in this case can simultaneously be used to clamp the seat to the seat post 36 and to replace a relevant clamp.

In the embodiment shown in FIG. 11, an arrangement with mounting brackets 60 attached to a support section is provided. A coupling part 10 can be attached to the support part by screw-mountable fastening elements 15. The mounting brackets 60 can be detachably mounted to a seat post 36 by a coupling unit 20. The mounting brackets 60 can accommodate one or more accessory parts or other items.

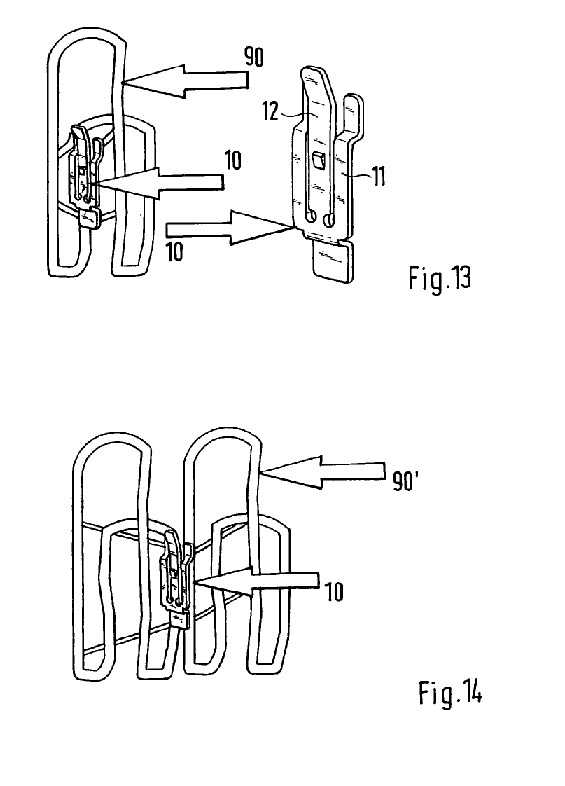

In an exemplary embodiment according to FIG. 12, a coupling part 10 is situated on an end surface of a container 40, for example a bag or a basket, and a mudguard is situated in the bottom region of the container 40, for example by another coupling part 10 attached to the bottom and a coupling unit 20 attached to the mudguard. The mudguard 70 mounted in this manner can be embodied as removable, for example, and can have a bracket 71 in its free end section to which, for example, a rear light can be attached. With the coupling part 10 situated on the side wall, the container 40 can be detachably mounted, for example, to a seat post 36 by a coupling unit 20 mounted there. Then the mudguard is positioned in a functionally appropriate fashion by the container.

The above-described coupling device enables numerous mounting possibilities with a uniform design.

1. A coupling device for releasably attaching accessories to a bicycle, having a coupling part (10, 10′) fastenable to the accessory and having a retaining section (11) mounted by being insertable into place and having a coupling unit (20, 20′, 20″) receiving said retaining section and permanently integrated into the bicycle or fastened to the bicycle by a connecting element, and having a receiving section (21, 21′) for an insertion of the retaining section (11), the coupling device comprising:
identical coupling units (20, 20′, 20″) permanently integrated into a plurality of locations on the bicycle or a different connector equipped with separate coupling units (20, 20′, 20″) and attached to the bicycle at different locations, and the coupling parts (10, 10′) attachable to various types of accessories.

2. The coupling device as recited in claim 1, wherein the coupling units (20, 20′, 20″) are integrated into or embodied with at least one of a connectible handlebar tube (32), a fork (33), a down tube (34) of the bicycle frame, a top tube (35) of the bicycle frame, a seat post (36), a seat tube (37), a luggage rack component or a holder mounted on the luggage rack.

3. The coupling device as recited in claim 2, wherein an additional coupling unit (20, 20′, 20″) is integrated into or connectible with a handlebar stem (31) of the bicycle.

4. The coupling device as recited in claim 3, wherein the coupling part (10, 10′) has a locking element (13), the coupling unit (20, 20′, 20″) has a locking receptacle (23) complementary to the locking element, and the locking element (13) and the locking receptacle (23) automatically engage with each other when the coupling part (10, 10′) and the coupling unit (20, 20′, 20″) are completely slid into each other.

5. The coupling device as recited in claim 4, wherein the locking element (13) and the locking receptacle (23) snap into each other by a spring force when the coupling part (10, 10′) and the coupling unit (20, 20′, 20″) are slid into each other and in order to release the locking action, the locking element (13) and/or the locking receptacle (23) each has a handle (12.1).

6. The coupling device as recited in claim 5, wherein the at least one coupling part (10, 10′) is attachable to the accessory by at least one screw connection or rivet connection, a welded connection or soldered connection, a bracket, an adhesive connection, a hook-and-loop connection, a detent connection, a clasp, or a support plate (41).

7. The coupling device as recited in claim 6, wherein the at least one coupling unit (20, 20′, 20″) is attached to the bicycle by at least one screw connection or rivet connection, a welded connection or soldered connection, a bracket, an adhesive connection, a hook-and-loop connection, a detent connection, a clasp, or a support element (38).

8. The coupling device as recited in claim 7, wherein the coupling part (10, 10′) and the coupling unit (20, 20′, 20″) are secured in a slid-together state by a permanent magnet holder.

9. The coupling device as recited in claim 8, wherein the permanent magnet holder has a permanent magnet positioned remote from the coupling region of the coupling part (10, 10′) and coupling unit (20, 20′, 20″) on the accessory or bicycle and has a magnetic or magnetizable counterpart element force-coupled to the bicycle or accessory.

10. The coupling device as recited in claim 9, wherein the accessory (40) is a container, a coupling part (10, 10′) is mounted to both a wall side and a bottom side of the container (40), and the container (40) is coupled to a seat post (36) or seat tube (37) by the wall-mounted coupling part (10, 10′) and is coupled to a mudguard (70) having a coupling unit (20, 20′, 20″) by the bottom coupling part (10, 10′).

11. The coupling device as recited in claim 1, wherein the coupling part (10, 10′) has a locking element (13), the coupling unit (20, 20′, 20″) has a locking receptacle (23) complementary to the locking element, and the locking element (13) and the locking receptacle (23) automatically engage with each other when the coupling part (10, 10′) and the coupling unit (20, 20′, 20″) are completely slid into each other.

12. The coupling device as recited in claim 11, wherein the locking element (13) and the locking receptacle (23) snap into each other by a spring force when the coupling part (10, 10′) and the coupling unit (20, 20′, 20″) are slid into each other and in order to release the locking action, the locking element (13) and/or the locking receptacle (23) each has a handle (12.1).

13. The coupling device as recited in claim 1, wherein the at least one coupling part (10, 10′) is attachable to the accessory by at least one screw connection or rivet connection, a welded connection or soldered connection, a bracket, an adhesive connection, a hook-and-loop connection, a detent connection, a clasp, or a support plate (41).

14. The coupling device as recited in claim 1, wherein the at least one coupling unit (20, 20′, 20″) is attached to the bicycle by at least one screw connection or rivet connection, a welded connection or soldered connection, a bracket, an adhesive connection, a hook-and-loop connection, a detent connection, a clasp, or a support element (38).

15. The coupling device as recited in claim 1, wherein the coupling part (10, 10′) and the coupling unit (20, 20′, 20″) are secured in a slid-together state by a permanent magnet holder.

16. The coupling device as recited in claim 15, wherein the permanent magnet holder has a permanent magnet positioned remote from the coupling region of the coupling part (10, 10′) and coupling unit (20, 20′, 20″) on the accessory or bicycle and has a magnetic or magnetizable counterpart element force-coupled to the bicycle or accessory.

17. The coupling device as recited in claim 1, wherein the accessory (40) is a container, a coupling part (10, 10′) is mounted to both a wall side and a bottom side of the container (40), and the container (40) is coupled to a seat post (36) or seat tube (37) by the wall-mounted coupling part (10, 10′) and is coupled to a mudguard (70) having a coupling unit (20, 20′, 20″) by the bottom coupling part (10, 10′).
